(19) United States
(12) Patent Application Publication
(10) Pub. No.: US 2025/0232934 A1
(43) Pub. Date: Jul. 17, 2025

(54) GUIDING PARTS FOR VACUUM CIRCUIT BREAKER

(71) Applicant: Schneider Electric Industries SAS, Rueil Malmaison (FR)

(72) Inventors: Renaud Carlen, Saint Quentin sur Isère (FR); Bhoopender Singh, Lappersdorf (DE); Satish Namala, Bangalore (IN); Martin Eigl, Regenstauf (DE)

(73) Assignee: Schneider Electric Industries SAS, Rueil Malmaison (FR)

(21) Appl. No.: 19/021,495

(22) Filed: Jan. 15, 2025

(30) Foreign Application Priority Data
Jan. 17, 2024 (EP) 24305112.5

(51) Int. Cl. H01H 33/662

(52) U.S. Cl. CPC H01H 33/66207

(57) ABSTRACT

A breaking module for a medium or high voltage switchgear. The breaking module includes a vacuum interrupter including a housing forming an enclosure in which a first electrical contact and a second electrical contact are disposed, the first and the second electrical contacts being configured to be moved relatively to each other between an open position and a closed position. The breaking module further includes a support frame; a first bracket fixed to the support frame and including a first radial abutment surface configured for receiving the vacuum interrupter housing; and a second bracket fixed to the first bracket, the second bracket including a second radial abutment surface configured for receiving the vacuum interrupter housing. The breaking module may be integrated in a circuit breaker.

### TECHNICAL FIELD

The disclosure relates to medium or high voltage electrical distribution systems, and more particularly to medium or high voltage vacuum interrupters. These vacuum interrupters are used in medium and high voltage electrical distribution devices, i.e. voltages greater than 1 kV. These vacuum interrupters are combined with actuators to selectively make or break the electrical current in some branches of an electrical distribution system.

### BACKGROUND ART

An electrical distribution system comprises one circuit breaker for each phase of the electrical network. Each circuit breaker comprises two electrical conductors, between which a vacuum interrupter is disposed. Each electrical conductor is attached to an electrical contact of the vacuum interrupter.

The electrical contacts of the vacuum interrupter are arranged in a cylindrical electrically insulating enclosure.

The vacuum interrupter is for example usually arranged vertically in the circuit breaker, and is mechanically fixed relatively to a frame of the circuit breaker.

For this, the vacuum interrupter is fixed on one of its ends to an electrical conductor which is itself fixed relatively to the frame of the circuit breaker.

The vacuum interrupter is also held in place, near its other end, by a clamping plate comprising a circular orifice. This end of the vacuum interrupter is pressed by the clamping plate in the vicinity of the circular orifice. The vacuum interrupter is thus held both in an axial direction and in a radial direction.

When assembling the circuit breaker, the insertion of the vacuum interrupter between the electrical conductor and the clamping plate can be difficult.

In particular, it is difficult to obtain an accurate positioning of the vacuum interrupter. The vacuum interrupter can for example be angularly offset relative to the two electrical conductors between which the vacuum interrupter is arranged.

This angular offset disturbs the operation of the vacuum interrupter and should be avoided.

One aim of the present disclosure is to propose a vacuum interrupter fixing system allowing a more precise positioning of the vacuum interrupter in a circuit breaker, as well as an easier assembly.

### SUMMARY

To this end, it is proposed a breaking module for a medium or high voltage switchgear, comprising:
a vacuum interrupter comprising a housing forming an enclosure in which a first electrical contact and a second electrical contact are disposed, the first and the second electrical contacts being configured to be moved relatively to each other along an axis between an open position in which the two contacts are separated from each other and a closed position in which the two contacts are contacting each other,
a support frame,
a first bracket fixed to the support frame and comprising a first radial abutment surface configured for limiting a radial movement of the vacuum interrupter relatively to the support frame,
a second bracket comprising a second radial abutment surface configured for limiting
   a radial movement of the vacuum interrupter relatively to the support frame, in which the second bracket is fixed to the first bracket.

The insertion of the vacuum interrupter in the breaking module can be performed while only the first bracket is fixed to the support frame. In this configuration, the insertion is easy since a large access volume is made available, since there's no hindrance from the second bracket. The second bracket can then be fixed to the first bracket once the vacuum interrupter is already positioned. The assembly of the vacuum interrupter in the breaking module is easier.

The following features can optionally be implemented, separately or in combination one with the others:

According to an aspect of the breaking module, the first bracket is configured for authorizing a translation movement of the vacuum interrupter relatively to the support frame.

Similarly, the second bracket is configured for authorizing an axial translation of the vacuum interrupter relatively to the support frame.

As no axial constraint is applied on the vacuum interrupter, no force tends to tilt the vacuum interrupter out of alignment. The relative position of the two electrical contacts of the vacuum interrupter can be maintained with an improved accuracy. The current breaking capacity of the vacuum interrupter can be more consistent throughout the lifetime duration of the vacuum interrupter.

The second bracket is reversibly fixed to the first bracket.

According to an aspect of the breaking module, the second bracket is fixed only to the first bracket.

In an embodiment of the breaking module, a radial gap between the first radial abutment surface and the vacuum interrupter is comprised between 0.1 millimeter and 1.0 millimeter.

Similarly, a radial gap between the second radial abutment surface and the vacuum interrupter is comprised between 0.1 millimeter and 1.0 millimeter.

This range of radial gap corresponds to a maximum angulation of the vacuum interrupter comprised between 0° and 5.0°.

An axial gap is present between the first bracket and the housing of the vacuum interrupter.

An axial gap is present between the second bracket and the housing of the vacuum interrupter.

In an embodiment of the breaking module, the first electrical contact is fixed relatively to the support frame and the second electrical contact can be moved relatively to the first electrical contact between the open position and the closed position, and

the first bracket and the second bracket define an opening through which the second electrical contact passes.

In an embodiment of the breaking module, the vacuum interrupter comprises a first end cap and a second end cap, each end cap closing a respective axial end of the housing, and the first bracket comprises a curved portion configured for receiving a first portion of one of the end caps.

The curved portion of the first bracket is for example semi-circular.

Similarly, the second bracket may comprise a curved portion configured for receiving a second portion of said one of the end caps.

The curved portion of the second bracket is for example semi-circular.

In an embodiment of the breaking module, the curved portion of the first bracket and the curved portion of the second bracket define a circular opening.

The first radial abutment surface and second radial abutment surface match the shape of the end cap to provide a radial support in any direction.

In an embodiment of the breaking module, the end cap comprises:
a first portion of discoidal shape, the first portion extending in a plan transverse to the axis of the housing, and
a second portion of cylindrical shape, the second portion extending along the axis of the housing,
   and the circular opening surrounds the second portion of the end cap.

The first bracket may be metallic.

The second bracket may be metallic.

The first bracket and the second bracket are for example cast parts.

The first end cap and the second end cap comprise metallic material.

A first end face of the first bracket and a first end face of the second bracket extend in a first common plane.

A second end face of the first bracket and a second end face of the second bracket extend in a second common plane.

The first common plane and the second common plane are parallel and transverse to the extension axis of the housing of the vacuum interrupter.

The housing and the two electrical contacts are co-axial.

The housing is in ceramic material, for example in alumina.

The vacuum interrupter comprises a first end cap and a second end cap, each end cap respectively closing an axial end of the housing.

In an embodiment of the breaking module, the first bracket comprises two positioning surfaces configured for contacting the support frame.

The two positioning surfaces may be located symmetrically relatively to the semi-circular opening.

The two positioning surfaces may extend perpendicularly to the axis of the electrical contacts of the vacuum interrupter.

In an embodiment of the breaking module, the support frame comprises two reception areas, each reception area being configured for receiving respectively a positioning surface of the first bracket.

The reception areas of the support frame are disposed, along an axial direction, between the vacuum interrupter housing and the first bracket.

The reception areas of the support frame may be disposed symmetrically relatively to a plan comprising the extension axis of the vacuum interrupter.

In an embodiment, the reception areas of the support frame extend perpendicularly to the axis of the electrical contacts of the vacuum interrupter.

In an example of implementation of the breaking module, a positioning surface of the first bracket comprises a positioning singularity configured for cooperating with a positioning singularity of a corresponding reception area of the support frame.

The positioning singularity helps positioning the first bracket with accuracy in the breaking module.

In an embodiment of the breaking module, each positioning surface of the first bracket comprises a positioning singularity configured for cooperating with a respective positioning singularity of each reception area of the support frame.

In an embodiment, the positioning singularity of a positioning surface is a protrusion and the positioning singularity of the reception area of the support frame is a recessed area.

In a variant, the positioning singularity of a positioning surface is a recessed area and the positioning singularity of the reception area of the support frame is a protrusion.

The recessed area may be a circular hole and the protrusion may be a cylindrical pin, and the cylindrical pin may pass through the cylindrical hole.

Similarly, the second bracket may comprise a positioning singularity configured for cooperating with a positioning singularity of a corresponding reception area of the support frame.

The positioning singularity may be a protrusion, which may be inserted in a recess of the reception area of the support frame.

According to an embodiment of the breaking module, the first bracket is fixed to the support frame by screws extending through the two positioning surfaces.

The fixing screws of the first bracket may be, but are not limited to, parallel to the axis of the electrical contacts.

According to another embodiment of the breaking module, the first bracket is fixed to the support frame by rivets extending through the two positioning surfaces.

According to another embodiment of the breaking module, the first bracket is fixed to the support frame by clips.

According to yet another embodiment of the breaking module, the first bracket is fixed to the support frame by glue. The glue is disposed between each positioning surface and the support frame.

In an embodiment of the breaking module, the second bracket is fixed to the first bracket by screws.

In another embodiment of the breaking module, the second bracket is fixed to the first bracket by clips.

The second bracket can be separated from the first bracket and fixed again, for example during a maintenance operation.

The fixing screws of the second bracket are for example, but not limited to, perpendicular to the axis of the electrical contacts.

The fixing screws of the second bracket may be located symmetrically relatively to the semi-circular opening.

In an embodiment of the breaking module, the first bracket comprises an abutment area configured for receiving an abutment area of the second bracket.

According to an embodiment, the abutment area of the first bracket and the abutment area of the second bracket have complementary shapes.

The accuracy of the relative position of the second bracket respectively to the first bracket is improved. Furthermore, the stability of the second bracket during the assembly operation is improved. Assembly is thus easier and the risk of having the second bracket falling during the assembly of the breaking module is reduced.

According to an embodiment, the first bracket is integral with the support frame.

The disclosure also relates to a medium or high voltage switchgear, configured for making and breaking current in a three-phase medium or high voltage electrical network, comprising a breaking module as described earlier respectively arranged on each phase of the electrical network.

A method of assembly of a breaking module is also proposed. The method of assembly comprises the steps:
providing a support frame, the support frame comprising a first current conducting rod configured to be fixed to an electrical contact of a vacuum interrupter,
providing a first bracket comprising a first radial abutment surface configured for receiving a vacuum interrupter housing,
fixing the first bracket to the support frame,
providing a vacuum interrupter comprising two electrical contacts displaceable relatively to each other,
positioning the vacuum interrupter against the first bracket and fixing one electrical contact of the vacuum interrupter to the first current conducting rod,
fixing the other electrical contact to a second current conducting rod,
switching the vacuum interrupter into a closed position of the electrical contacts,
fixing of the second bracket to the first bracket in order to clamp the vacuum interrupter relatively to the support frame.

The vacuum interrupter is inserted in the breaking module while only the first bracket is fitted. The insertion is thus easy. The vacuum interrupter is then fixed to the fixed current conducting rod. One end of the vacuum interrupter is thus fixed, and the other end is still free. The electrical contacts are then closed so that the vacuum interrupter housing self-orientates itself in a angular position corresponding to the real internal forces between the two contacts. Then the second bracket is fitted and fixed to the first bracket, while the electrical contacts are still closed. No external axial or radial constraint is applied on the housing of the vacuum interrupter during the assembly operation. Only axial efforts resulting from the closure of the electrical contacts are applied. Therefore, the risk of misalignment of the vacuum interrupter respectively to its preferred orientation is eliminated.

The first current conducting rod is fixed relatively to the support frame.

The second current conducting rod can be moved relatively to the support frame.

### BRIEF DESCRIPTION OF DRAWINGS

Other features, details and advantages will be shown in the following detailed description and on the figures, on which:

FIG. 1 is a schematic view of a medium or high voltage switchgear,

FIG. 2 is a perspective view of a breaking module according to an embodiment, in a fully assembled state,

FIG. 3 is a partial perspective view of the breaking module of FIG. 2,

FIG. 4 is another partial perspective view of the breaking module of FIG. 2,

FIG. 5 is another partial perspective view of the breaking module of FIG. 2,

FIG. 6 is a top view and bottom view of the breaking module of FIG. 2,

FIG. 7 represents two perspective views of the fixing brackets of the break module of FIG. 2,

FIG. 8 illustrates different steps of the assembly process of the breaking module of FIG. 2,

FIG. 9 illustrates subsequent steps of the assembly process of the breaking module of FIG. 2,

FIG. 10 is a block diagram of different steps of an assembly method of a breaking module according to an embodiment.

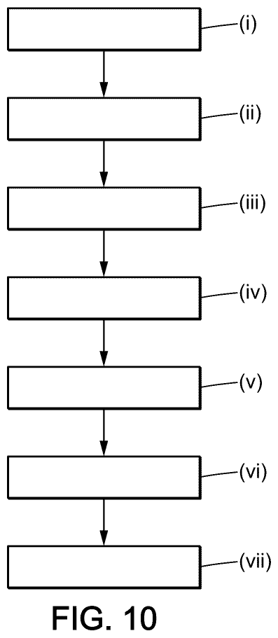

### DESCRIPTION OF EMBODIMENTS

In order to make the figures easier to read, the various elements are not necessarily represented to scale. In these figures, identical elements receive the same reference number. Certain elements or parameters can be indexed, that is to say designated for example by ‘first element’ or second element, or first parameter and second parameter, etc. The purpose of this indexing is to differentiate elements or parameters that are similar, but not identical. This indexing does not imply a priority of one element, or one parameter over another, and their names can be interchanged. When it is mentioned that a subsystem comprises a given element, the presence of other elements in this subsystem is not excluded.

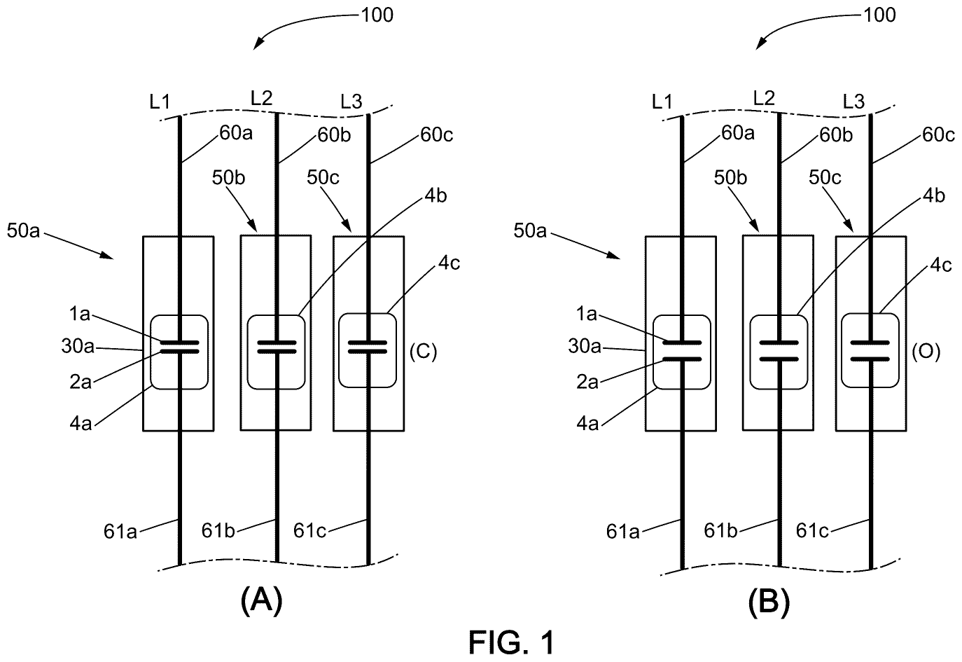

FIG. 1 schematically illustrates a medium or high voltage switchgear 100, configured for making and breaking current in a three-phase L1, L2, L3 medium or high voltage electrical network. The medium or high voltage switchgear 100 comprises a breaking module 50a, 50b, 50c respectively arranged on each phase L1, L2, L3 of the electrical network.

For each of the three phases, the switchgear 100 comprises a first current conducting rod and a second current conducting rod. Reference signs 60a, 60b, 60c correspond respectively to the first current conducting rod of each of the three phases L1, L2, L3. Similarly, reference signs 61a, 61b, 61c correspond respectively to the second current conducting rod of each of the three phases L1, L2, L3.

For each phase, a vacuum interrupter is inserted between the first current conducting rod and the second current conducting rod.

Reference sign 4a refers to the vacuum interrupter dedicated to the first phase L1, 4b refers the vacuum interrupter dedicated to the second phase L2, and 4c refers to the vacuum interrupter dedicated to the second phase L3.

Each vacuum interrupter 4a, 4b, 4c is respectively integrated in a breaking module 50a, 50b, 50c. Each breaking module 50a, 50b, 50c can interrupt the electrical current of the corresponding phase L1, L2, L3.

The breaking modules may be identical.

Each breaking module corresponds to a specific design that will be described in details hereafter. Reference sign 50 refers to the proposed design, independently of the electrical phase it refers to.

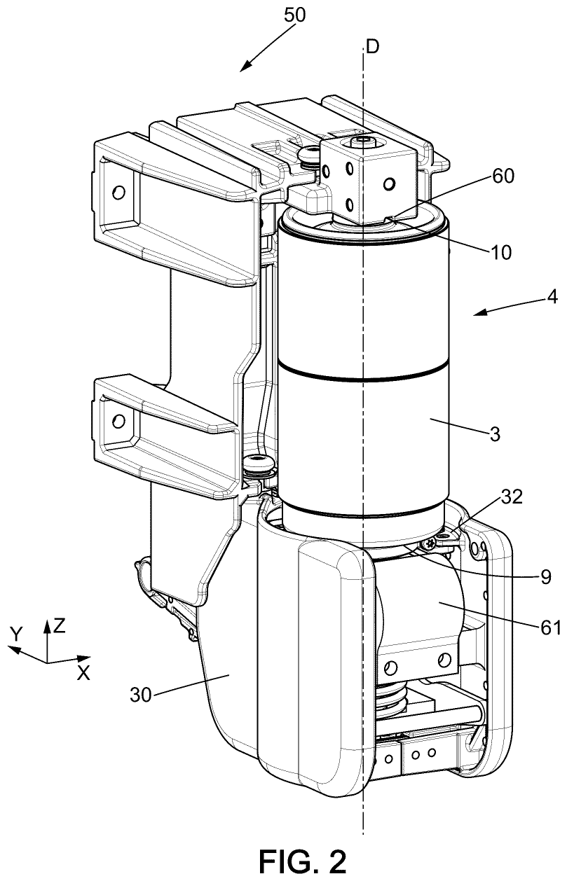

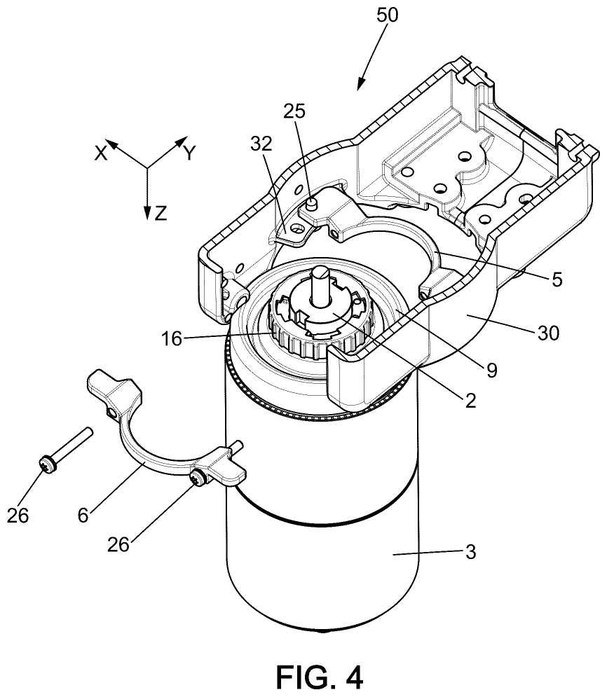

FIGS. 2 to 7 represent an embodiment of the proposed breaking module.

The breaking module 50, for a medium or high voltage switchgear 100, comprises:
a vacuum interrupter 4 comprising a housing 3 forming an enclosure in which a first electrical contact 1 and a second electrical contact 2 are disposed, the first 1 and the second 2 electrical contacts being configured to be moved relatively to each other along an axis D between an open position O in which the two contacts 1,2 are separated from each other and a closed position C in which the two contacts 1,2 are contacting each other,
a support frame 30,
a first bracket 5 fixed to the support frame 30 and comprising a first radial abutment surface 7 configured for limiting a radial movement of the vacuum interrupter 4 relatively to the support frame 30,
a second bracket 6 comprising a second radial abutment surface 8 configured for limiting a radial movement of the vacuum interrupter 4 relatively to the support frame 30, in which the second bracket 6 is fixed to the first bracket 5.

During assembly of the breaking module 50, the vacuum interrupter 4 can be inserted in the breaking module 50 while only the first bracket 5 is fixed to the support frame 30. In this configuration, the insertion is easy since a large access volume is made available around a vacuum interrupter 4, as there's no hindrance from the second bracket 6 which isn't present at this stage. Once the vacuum interrupter 4 has been positioned against the first bracket 5, the second bracket 6 can then be fixed to the first bracket 5 to secure the installation of the vacuum interrupter 4. The assembly of the vacuum interrupter 4 in the breaking module 50 is easier, and the risk of misalignment of the vacuum interrupter 4 relatively to the support frame 30 is eliminated.

A first current conducting rod 60 is fixed relatively to the support frame 30. The first current conducting rod 60 is fixed to the first electrical contact 1.

The second current conducting rod 61 is fixed to the second electrical contact 2.

The second current conducting rod 61 can be moved relatively to the support frame 30.

A transition between a closed state and an opened state of the vacuum interrupter 4 is achieved by a translation stroke of the second electrical contact 2.

To allow a translation movement of the second electrical contact 2, the second current conducting rod 61 comprises a flexible strip 62 to accommodate the displacement of the mobile electrical contact 2 of the vacuum interrupter 4.

The flexible strip 62 has a curved shape, and the curvature of the flexible strip 62 is modified between the closed position C and the opened position O of the vacuum interrupter 4.

In the illustrated example, the first electrical contact 1 is fixed relatively to the housing 3 of the vacuum interrupter 4. The second electrical contact 2 can be translated along its extension axis relatively to the housing 3.

The first bracket 5 is configured for authorizing a translation movement of the vacuum interrupter 4 relatively to the support frame 30.

Similarly, the second bracket 6 is configured for authorizing an axial translation of the vacuum interrupter 4 relatively to the support frame 30.

As no axial constraint is applied on the vacuum interrupter 4, no force tends to tilt the vacuum interrupter 4 out of alignment. The relative position of the two electrical contacts 1,2 of the vacuum interrupter 4 can be maintained with an improved accuracy. The current breaking capacity of the vacuum interrupter 4 can be more consistent throughout the lifetime duration of the vacuum interrupter 4.

The second bracket 6 is reversibly fixed to the first bracket 5.

The second bracket 6 can be detached from the first bracket 5, and then reattached to the first bracket 5. This temporary dismantling can for example take place during a maintenance operation in which a new vacuum interrupter is fitted in the breaking module.

Similarly, the first bracket 5 is reversibly fixed to the support frame 30. If required, the first bracket 5 can be detached from the support frame 30, and then reattached.

The second bracket 6 is fixed only to the first bracket 5.

In other words, the second bracket 6 has no direct mechanical connection with the support frame 30. The second bracket 6 is rigidly linked to the first bracket 5, which is itself rigidly linked to the support frame 30.

In the illustrated embodiment of the breaking module 50, a radial gap between the first radial abutment surface 7 and the vacuum interrupter 4 is comprised between 0.1 millimeter and 1.0 millimeter.

A radial gap between the second radial abutment surface 8 and the vacuum interrupter 4 is comprised between 0.1 millimeter and 1.0 millimeter.

The first bracket 5 and second bracket 6 maintain the spatial location of the vacuum interrupter 4 during the opening and closing sequences of the vacuum interrupter 4. No radial constraint is exerted as long as the vacuum interrupter 4 doesn't lean against one side of one fixing bracket or both fixing brackets 5,6.

This range of radial gap corresponds to a maximum angulation of the vacuum interrupter 4 comprised between 0° and 5.0°.

An axial gap is present between the first bracket 5 and the housing 3 of the vacuum interrupter 4.

An axial gap is present between the second bracket 6 and the housing 3 of the vacuum interrupter 4.

In the illustrated embodiment of the breaking module 50, the first electrical contact 1 is fixed relatively to the support frame 30 and the second electrical contact 2 can be moved relatively to the first electrical contact 1 between the open position O and the closed position C, and

the first bracket 5 and the second bracket 6 define an opening through which the second electrical contact 2 passes.

Once the breaking module 50 is assembled, the second electrical contact 2 is surrounded by the opening defined by the first bracket 5 and the second bracket 6. The axial position of the second electrical contact 2 relatively to the first bracket 5 and the second bracket 6 is dependent on the electrical state of the vacuum interrupter, this position differing whether the vacuum interrupter 4 is in opened position or closed position.

On the different figures, the actuation mechanism enabling to open or close the vacuum interrupter 4 has not been represented and will not be described here.

The vacuum interrupter 4 comprises a first end cap 9 and a second end cap 10, each end cap 9, 10 respectively closing an axial end of the housing 3.

The first end cap 9 seals the axial end of the housing 3 corresponding to the second contact 2, which is here the fixed contact.

The second end cap 10 seals the axial end of the housing 3 corresponding to the first contact 1, which is here the mobile contact.

The vacuum interrupter 4 comprises a first end cap 9 and a second end cap 10. Each end cap 9, 10 closes a respective axial end of the housing 3. The first bracket 5 comprises a curved portion 11 configured for receiving a first portion of one 9 of the end caps 9, 10.

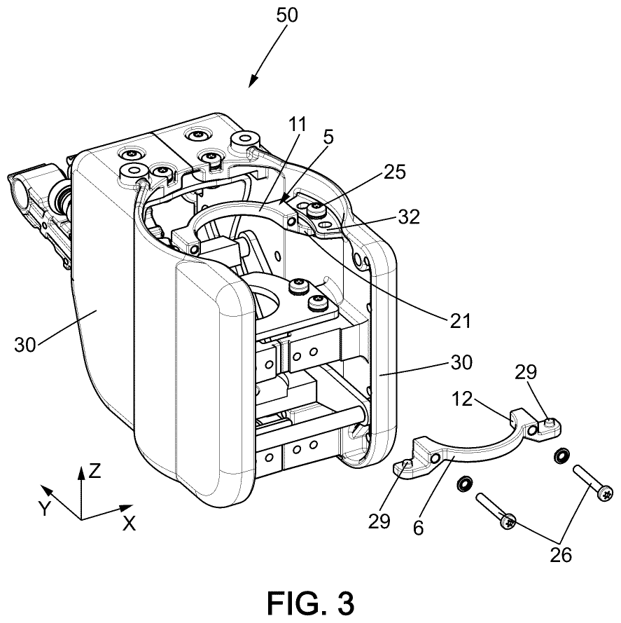

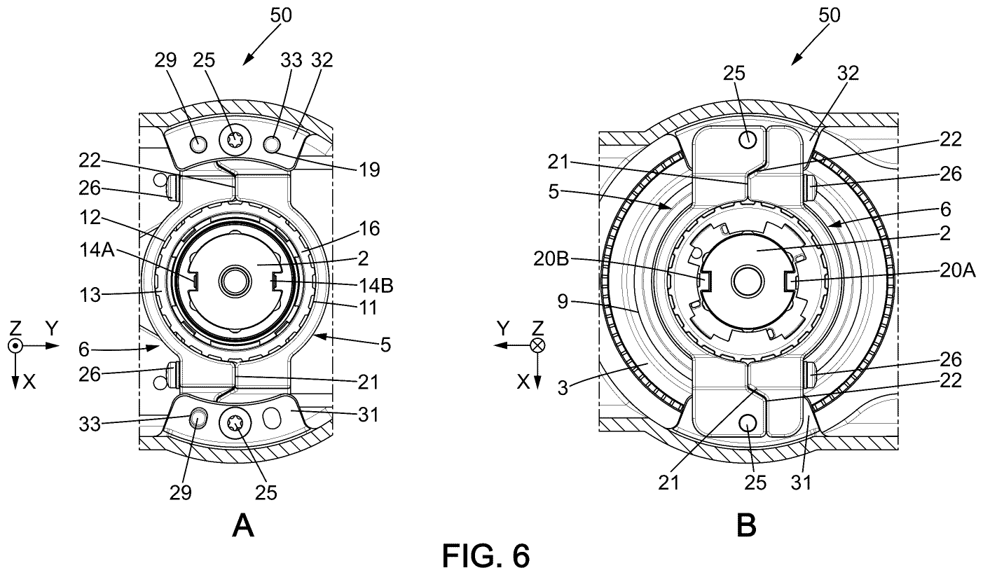

The curved portion 11 of the first bracket 5 is for example semi-circular, as particularly visible on FIG. 3 and FIG. 6.

In the same way, the second bracket 6 comprises a curved portion 12 configured for receiving a second portion of said one 9 of the end caps.

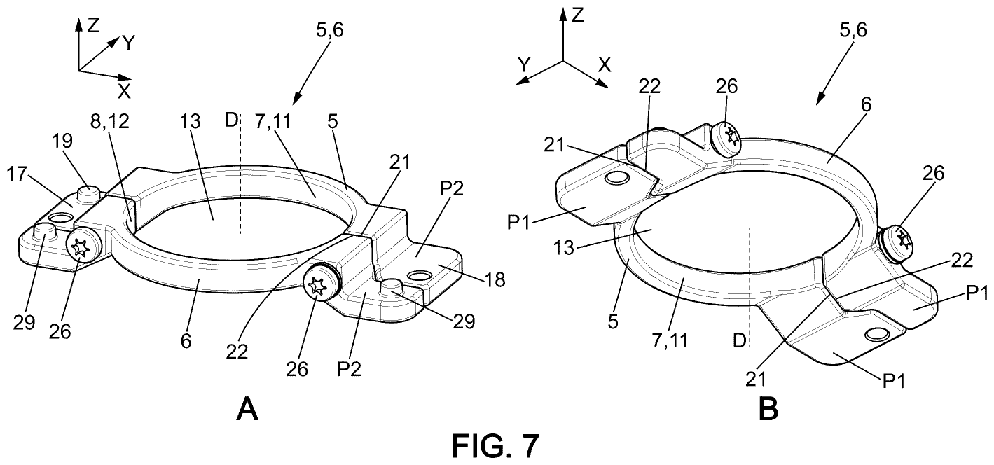

As particularly represented on FIG. 7, the curved portion 12 of the second bracket 6 is here semi-circular.

The curved portion 11 of the first bracket 5 and the curved portion 12 of the second bracket 6 define a circular opening 13.

The first radial abutment surface 7 and the second radial abutment surface 8 match the shape of the end cap 9 to provide a radial support in any direction transverse to the axis D of the vacuum interrupter.

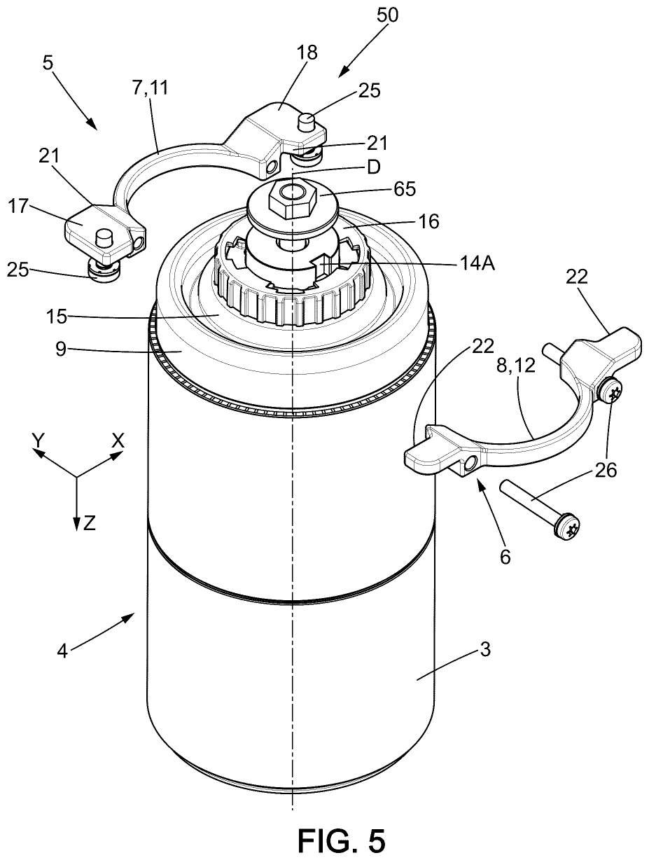

As illustrated on FIG. 5, the end cap 9 comprises:
a first portion 15 of discoidal shape, the first portion 15 extending in a plan transverse to the axis D of the housing 3, and
a second portion 16 of cylindrical shape, the second portion 16 extending along the axis D of the housing 3,
   and the circular opening 13 surrounds the second portion 16 of the end cap 9.

The second portion 16 is fixed relatively to the first portion 15.

The second portion 16 comprises two protruding lugs 20A, 20B.

The second electrical contact 2 comprises two grooves 14A, 14B.

The protruding lugs 20A, 20B and the grooves 14A, 14B have complementary shapes. A first lug 20A extends in a first groove 14A, and a second lug 20B extends in a second groove 14B. FIG. 6 makes this feature particularly apparent.

The arrangement of the lugs 20A, 20B of the second portion 16 and of the grooves 14A, 14B of the second electrical contact 2 provide an anti-twist function. In other words, a rotation of the second electrical contact 2 respectively to its extension axis is prevented. The torsion torque resulting from the assembly of the second electrical contact 2 with the second current conduction rod 61 is prevented. This torque is applied when the fixing screw 65, illustrated on FIG. 5, is tightened to fix the second electrical contact 2.

The grooves 14A, 14B are symmetrical from each other respectively to the extension axis of the second electrical contact 2.

In the same way, the lugs 20A, 20B are symmetrical from each other respectively to the extension axis of the second electrical contact 2.

The second portion 16 is also called anti-twist cap. Its lateral external surface is splined so that a tool can securely hold it during the assembly.

The first bracket 5 may be metallic.

The second bracket 6 may be metallic.

The first bracket 5 and the second bracket 6 are for example cast parts.

The abutment surfaces 7,8 may be machined.

The abutment surfaces 7,8 may remain as-cast.

The first bracket 5 can also be made of plastic material. Similarly, the second bracket 6 may be made of plastic material.

The first end cap 9 and the second end cap 10 comprise metallic material. The second end cap 10, corresponding to the fixed contact 1, is made of metal. The first end cap 9, corresponding to the mobile contact 2, comprises a first portion 15 5 in metal. The second part 16 may be a plastic part fixed to the first portion 15. The first end cap 9 and the second end cap 10 are soldered to the housing 3 of the vacuum interrupter 4.

As illustrated on FIG. 7, a first end face of the first bracket 5 and a first end face of the second bracket 6 extend in a first common plane P1.

In this example, a second end face of the first bracket 5 and a second end face of the second bracket 6 extend in a second common plane P2.

The first common plane P1 and the second common plane P2 are parallel and transverse to the extension axis D of the housing 3 of the vacuum interrupter 4.

The housing 3 and the two electrical contacts 1,2 are co-axial.

The housing 3 is electrically insulating. The housing is of cylindrical shape.

The housing 3 is in ceramic material, for example in alumina.

In the illustrated embodiment of the breaking module 50, the first bracket 5 comprises two positioning surfaces 17, 18 configured for contacting the support frame 30.

The two positioning surfaces 17, 18 are located symmetrically relatively to the semi-circular opening.

The two positioning surface 17, 18 extend perpendicularly to the axis D of the electrical contacts 1,2 of the vacuum interrupter 4.

The two positioning surface 17, 18 can be observed on FIG. 5 in which the first bracket 5 and the second bracket 6 are separated and offset from the vacuum interrupter 4, and on FIG. 7 in which the two brackets are fixed together with the vacuum interrupter not represented.

The support frame 30 comprises two reception areas 31, 32. Each reception area 31,32 is configured for receiving respectively a positioning surface 17,18 of the first bracket 5.

The reception areas 31, 32 of support frame 30 are disposed, along an axial direction, between the vacuum interrupter housing 3 and the first bracket 5.

The reception areas 31, 32 of the support frame 30 may be disposed symmetrically relatively to a plan comprising the extension axis of the vacuum interrupter 4.

In the illustrated embodiment, the reception areas 31,32 of the support frame 30 extend perpendicularly to the axis D of the electrical contacts 1,2 of the vacuum interrupter 4.

A positioning surface 17 of the first bracket 5 comprises a positioning singularity 19 configured for cooperating with a positioning singularity 33 of a corresponding reception area 31, 32 of the support frame 30.

The positioning singularity 19 helps positioning the first bracket 5 with accuracy in the breaking module 50 during the assembly process.

In a non-represented example, each positioning surface 17, 18 of the first bracket 5 may comprise a positioning singularity 19 configured for cooperating with a respective positioning singularity 33 of each reception area 31, 32 of the support frame 30.

As represented on FIG. 7, the positioning singularity 19 of a positioning surface 17,18 is a protrusion and the positioning singularity 33 of the reception area 31, 32 of the support frame 30 is a recessed area.

The recessed area 33 is here a circular hole.

In a non-represented variant, the positioning singularity 19 of a positioning surface 17,18 may be a recessed area and the positioning singularity of the reception area 31,32 of the support frame 30 may be a protrusion.

The recessed area may be a circular hole and the protrusion may be a cylindrical pin, and the cylindrical pin may pass through the cylindrical hole. The circular hole may be a through hole or a blind hole.

The first bracket 5 is fixed to the support frame 30 by screws 25 extending through the two positioning surfaces 17, 18.

The fixing screws 25 of the first bracket 5 are here, but not limited to, parallel to the axis D of the electrical contacts 1,2.

The second bracket 6 is fixed to the first bracket 5 by screws 26.

The second bracket 6 can thus be separated from the first bracket 5 and then reassembled, for example during a maintenance operation.

The fixing screws 26 of the second bracket 6 are for example, but not limited to, perpendicular to the axis D of the electrical contacts.

The fixing screws 26 of the second bracket 6 are located symmetrically relatively to the semi-circular opening 13.

The first bracket 5 comprises an abutment area 21 configured for receiving an abutment area 22 of the second bracket 6.

The abutment area 21 of the first bracket 5 and the abutment area 22 of the second bracket 6 have complementary shapes.

The accuracy of the relative position of the second bracket 6 respectively to the first bracket 5 is improved. Furthermore, the stability of the second bracket 6 during the assembly operation is improved. Assembly is thus easier and the risk of having the second bracket 6 falling off from the breaking module 50 during its assembly is reduced.

Similarly, the second bracket 6 comprises a positioning singularity 29 configured for cooperating with a positioning singularity 34 of a corresponding reception area of the support frame 30. The positioning singularity may be a protrusion.

In the illustrated embodiment, the second bracket 6 comprises two protrusions 29 shaped as a cylindrical pin. Each protrusion 29 can be fitted in a positioning singularity 34 of the support frame 30. The assembly of the second bracket 6 on the first bracket 5 is made easier, as the second bracket 6 can be maintained in its correct position before the fixing screws 26 are fitted.

In alternative embodiments, not represented, the first bracket 5 is fixed to the support frame 30 by alternative fixing means.

The first bracket 5 can be fixed to the support frame 30 by rivets extending through the two positioning surfaces 17, 18.

The insertion direction of the rivets may be identical to the direction of the fixing screws already described.

In another variant of the breaking module 50, the first bracket 5 is fixed to the support frame 30 by clips.

The clips may be disposed on the first bracket 5, with counterparts such as slots disposed on the support frame 30.

Alternatively, the clips may be disposed on the support frame 30, with counterparts such as slots disposed on the first bracket 5.

The clips are elastically deformed by their insertion in the slots, and can spread once they are fully engaged in the slots. A rigid fixing of the parts is thus provided.

If necessary, the clips may be deformed by an operator to allow disassembly.

In another non-represented variant of the breaking module 50, the first bracket 5 is fixed to the support frame 30 by glue.

The glue is disposed between each positioning surface 17, 18 and the corresponding reception areas 31, 32 of the support frame 30.

Similarly, in another non-represented embodiment of the breaking module, the second bracket 6 is fixed to the first bracket 5 by clips.

If necessary, the clips may be deformed by an operator to allow disassembly.

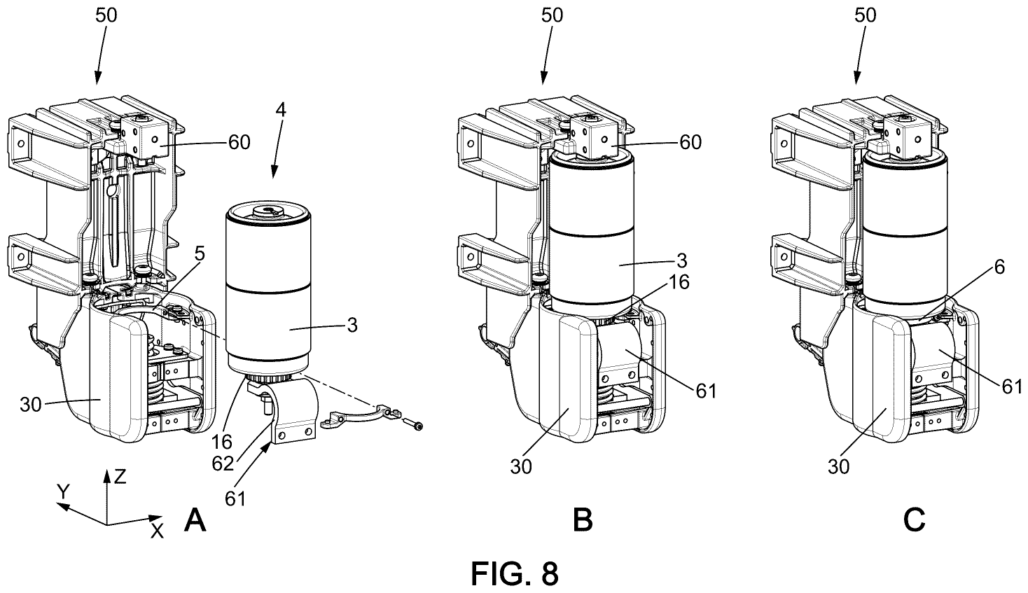

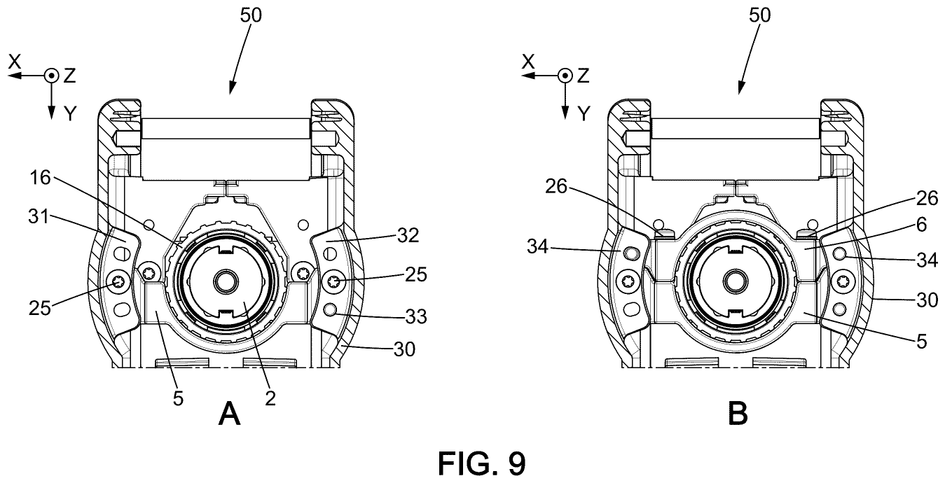

A method of assembly of a breaking module 50 will now be described. FIG. 8 and FIG. 9 illustrate different steps of the assembly process, in chronological order.

The method of assembly comprises the steps:
(i) providing a support frame 30, the support frame 30 comprising a first current conducting rod 60 configured to be fixed to an electrical contact of a vacuum interrupter 4,
(ii) providing a first bracket 5 comprising a first radial abutment surface 7 configured for receiving a vacuum interrupter housing 3,
(iii) fixing the first bracket 5 to the support frame 30,
(iv) providing a vacuum interrupter 4 comprising two electrical contacts 1,2 displaceable relatively to each other, a first electrical contact 1 of the vacuum interrupter 4 being fixed to a first current conducting rod 60 and a second electrical contact 2 being fixed to a second current conducting rod 61,
(v) positioning the vacuum interrupter 4 against the first bracket 5,
(vi) switching the vacuum interrupter 4 into a closed position C of the electrical contacts 1,2,
(vii) fixing of the second bracket 6 to the first bracket 5 in order to clamp the vacuum interrupter 4 relatively to the support frame 30.

The vacuum interrupter 4 is inserted in the breaking module 50 while only the first bracket 5 is fitted. The insertion is thus easy, even though the vacuum interrupter is already connected to the first current conducting rod 60 and to the second current conducting rod 61. Indeed, at this stage the second bracket 6 is not present, which gives the possibility of a lateral access in a direction transverse to the current conducting rods. There's no hindrance for the vacuum interrupter insertion.

Part A of FIG. 8 illustrates the vacuum interrupter 4 before its insertion in the support frame 30, therefore offset from the support frame 30. On part A of FIG. 6, the first bracket 5 is already fitted to the support frame 30.

Part B of FIG. 8 illustrates the vacuum interrupter 4 after it has been inserted in the support frame 30, and after the first electrical contact 1 has been fixed to the first current conduction rod 60. The contacts 1, 2 are in closed position, and are contacting each other with a contact pressure applied by the actuation mechanism of the breaking module 50. The second bracket 6 is not fitted yet.

As the electrical contacts 1,2 are closed, the vacuum interrupter housing 3 self-orientates itself in an angular position corresponding to the real internal forces between the two contacts 1,2. Then the second bracket 6 is fitted and fixed to the first bracket 5, while the electrical contacts 1,2 are still closed. No external axial or radial constraint is applied on the housing 3 of the vacuum interrupter 4 during the assembly operation. Only axial efforts resulting from the closure of the electrical contacts 1,2 are applied. Therefore, the risk of misalignment of the vacuum interrupter 4 respectively to its preferred orientation is eliminated.

Part C of FIG. 6 represents the breaking module 50 with the second bracket 6 fitted and fixed to the first bracket 5. The assembly is completed.

Part A of FIG. 9 illustrates the breaking module 50 after the insertion of the vacuum interrupter 4, and before the second bracket 6 is assembled, from a different view angle compared to FIG. 8.

Part B of FIG. 9 represents the breaking module 50 with the second bracket 6 fitted and secured by screws 26. Part B of FIG. 9 corresponds to part C of FIG. 8, from a different view angle.

In a non-represented embodiment, the first electrical contact 1 can also be translated relatively to the housing 3 of the vacuum interrupter. In other words, both electrical contacts 1,2 are mobile.

In a non-represented embodiment, the first fixing bracket 5 is integral with the support frame 30.

For example, the fixing bracket 5 is cast simultaneously with the support frame 30. In the case, the steps (i), (ii) and (iii) of the method of assembly come together and are simultaneously performed.

1. A breaking module for a medium or high voltage switchgear, comprising:
a vacuum interrupter comprising a housing forming an enclosure in which a first electrical contact and a second electrical contact are disposed, the first and the second electrical contacts being configured to be moved relatively to each other along an axis between an open position in which the two contacts are separated from each other and a closed position in which the two contacts are contacting each other,
a support frame,
a first bracket fixed to the support frame and comprising a first radial abutment surface configured for limiting a radial movement of the vacuum interrupter relatively to the support frame,
a second bracket comprising a second radial abutment surface configured for limiting a radial movement of the vacuum interrupter relatively to the support frame, wherein the second bracket is fixed to the first bracket.

2. The breaking module according to claim 1, wherein:
the first bracket is configured for authorizing a translation movement of the vacuum interrupter relatively to the support frame, and
the second bracket is configured for authorizing an axial translation of the vacuum interrupter relatively to the support frame.

3. The breaking module according to claim 1, wherein the first electrical contact is fixed relatively to the support frame and the second electrical contact can be moved relatively to the first electrical contact (1) between the open position and the closed position, wherein the first bracket and the second bracket define an opening through which the second electrical contact passes.

4. The breaking module according to claim 1, wherein the vacuum interrupter comprises a first end cap and a second end cap, each end cap closing a respective axial end of the housing, and wherein:
the first bracket comprises a curved portion configured for receiving a first portion of one of the end caps, and
the second bracket comprises a curved portion configured for receiving a second portion of said one of the end caps.

5. The breaking module according to claim 4, wherein the curved portion of the first bracket and the curved portion of the second bracket define a circular opening.

6. The breaking module according to claim 5, wherein the end cap comprises:
a first portion of discoidal shape, the first portion extending in a plan transverse to the axis of the housing, and
a second portion of cylindrical shape, the second portion extending along the axis of the housing,
and wherein the circular opening surrounds the second portion of the end cap.

7. The breaking module according to claim 1, wherein the first bracket comprises two positioning surfaces configured for contacting the support frame, and
wherein the support frame comprises two reception areas, each reception area being configured for receiving respectively a positioning surface of the first bracket.

8. The breaking module according to claim 7, wherein a positioning surface of the first bracket comprises a positioning singularity configured for cooperating with a positioning singularity of a corresponding reception area of the support frame.

9. The breaking module according to claim 8, wherein each positioning surface of the first bracket comprises a positioning singularity configured for cooperating with a respective positioning singularity of each reception area of the support frame.

10. The breaking module according to claim 1, wherein the first bracket is fixed to the support frame by screws extending through the two positioning surfaces.

11. The breaking module according to claim 10,
wherein the fixing screws of the first bracket are parallel to the axis of the electrical contacts.

12. The breaking module according to claim 1, wherein the second bracket is fixed to the first bracket by screws, and
wherein the fixing screws of the second bracket are perpendicular to the axis of the electrical contacts.

13. The breaking module according to claim 1, wherein the first bracket comprises an abutment area configured for receiving an abutment area of the second bracket, and
wherein the abutment area of the first bracket and the abutment area of the second bracket have complementary shapes.

14. A medium or high voltage switchgear, configured for making and breaking current in a three-phase medium or high voltage electrical network, comprising the breaking module according to claim 1 respectively arranged on each phase of the electrical network.

15. A method of assembly of the breaking module according to claim 1, comprising:
providing a support frame, the support frame comprising a first current conducting rod configured to be fixed to an electrical contact of a vacuum interrupter,
providing a first bracket comprising a first radial abutment surface configured for receiving a vacuum interrupter housing,
fixing the first bracket to the support frame,
providing a vacuum interrupter comprising two electrical contacts displaceable relatively to each other,
positioning the vacuum interrupter against the first bracket and fixing one electrical contact of the vacuum interrupter to the first current conducting rod,
fixing the other electrical contact to a second current conducting rod,
switching the vacuum interrupter into a closed position of the electrical contacts, and
fixing of the second bracket to the first bracket in order to clamp the vacuum interrupter relatively to the support frame.
